(19) United States
(12) Patent Application Publication
(10) Pub. No.: US 2004/0137327 A1
(43) Pub. Date: Jul. 15, 2004

(54) Synthesis of carbon/silicon composites

(76) Inventors: Karl J. Gross, Fremont, CA (US); James C.F. Wang, Livermore, CA (US); Gregory A. Roberts, Dublin, CA (US)

Correspondence Address: Timothy Evans, Sandia National Laboratories, 7011 East Avenue, MS 9031, Livermore, CA, 94550, US

(21) Appl. No.: 10/341,843

(22) Filed: Jan. 13, 2003

(51) Int. Cl. H01M 4/58; H01M 4/62

(52) U.S. Cl. 429/231.8; 429/232; 429/252; 252/182.1

(57) ABSTRACT

The present embodiment relates to a method for preparing a composite graphite-silicon negative electrode material whereby an essentially dry mixture of graphite carbon powder and an element or elements selected from the new IUPAC Group Number 12-15 of the Periodic Table of Elements that can form alloys or compounds with lithium is prepared to provide an electrochemically active mixture. A mechanical agitation process serves to mix the constituent materials and to produce a fine dispersion with intimate contact between graphite and the Group 12-15 materials. A lithium ion battery negative electrode of this composition takes synergistic advantage of the high lithium capacity of some IUPAC Group materials and the long cycle-life of graphite negative electrode materials.

### STATEMENT OF GOVERNMENT INTEREST

This invention was made with Government support under government contract no. DE-AC04-94AL85000 awarded by the U.S. Department of Energy to Sandia Corporation. The Government has certain rights in the invention, including a paid-up license and the right, in limited circumstances, to require the owner of any patent issuing in this invention to license others on reasonable terms.

### FIELD OF THE INVENTION

This embodiment of the invention relates to a method for preparing a carbon/silicon powder mixture for use as a material for a negative electrode in a rechargeable lithium-ion electrochemical cell. In particular, the embodiment relates to a method for providing a dry mixture of a carbon graphite powder and a sub-micron silicon powder that are mechanically milled together to provide a physically intimate composite of these materials. The embodiment further relates to the application of said prepared carbon-silicon powders as a material for an active negative electrode in rechargeable lithium-ion electrochemical cells

### BACKGROUND OF THE INVENTION

As consumer demand drives electronic appliances (PDAs, lap-top and handheld computers, camcorders, digital cameras, and cellular phones) to become increasingly portable and connected, these appliances have become smaller, lighter, and much more reliant on energy storage means that are dense and reusable. In order to address these needs, much research and commercial development of electrochemical systems relying upon lithium beginning in the late 1960's through the present day. Unfortunately, issues of safety and cell life had limited wide-spread commercial acceptance of lithium battery technology until very recently with the introduction of a new generation of lithium-ion secondary batteries that has resolved problems associated with lithium-metal secondary batteries such as safety, short cycle life, low charge speed, and the like.

The rechargeable battery industry, however, has remained under pressure to increase the energy output and long term life and reliability of these storage devices. What is needed is a lithium-ion secondary battery that is both safe and reliable, one that exhibits a high energy density, is small and light weight, and having a charge-discharge cycle capability running from tens to hundreds of cycles before failure.

Lithium-ion rechargeable batteries comprise a family of intercalation-type electrochemical systems, in which a layered material capable of reversibly incorporating (i.e., “intercalating”), lithium ions into and out of its crystal lattice during cell charging/discharging, meeting many of these needs. Cells comprising carbonaceous materials, such as graphite, that are capable of intercalating lithium ions during charging can be used as a negative electrode material, while compounds such as oxides of transition metals that are capable of intercalating lithium ions during cell discharge, can be used as a positive electrode materials.

A class of materials capable of forming compounds or alloys with lithium have been proposed as negative electrode materials. Lithium alloys comprising tin, aluminum, silicon, cadmium, lead, bismuth and antimony contain significant amounts of lithium that, in principle, can be extracted and re-alloyed. Unfortunately, in practice, there are substantial volume charges associated with changing the stoichiometry of lithium in these alloys. These volume changes effect the performance of an electrochemical cell using these alloys. Alloys used for this purpose tend to crack and fragment upon repeated alloying/extraction cycles. This fragmentation of the active material leads to integrity problems for the negative electrode and a corresponding increase in the surface area of the electrode itself. These effects cooperatively operate to degrade the performance of the cell by promoting parasitic consumption of the lithium in the alloy, via reaction with the battery electrolyte to form passivating films on newly exposed lithium surface and by electronically isolating portions of the fragmented materials effectively rendering it inactive. Since this reaction is irreversible, the overall result is an irreversible loss of capacity usually manifested with a rapid decline with each charge/recharge cycle. Furthermore, battery safety is compromised as fresh lithium surface is exposed since this state can lead to an increased sensitivity to thermal runaway.

However, the use of insertion compounds having layered crystal lattices, such as graphite, to prepare negative electrodes for lithium cells avoids many of the aforementioned problems since the volume change associated with lithium insertion into these materials, is small. Consequently, little or no fragmentation of these compounds occurs and the integrity of the negative electrode is maintained. Furthermore, because the negative electrode material does not fragment, the lithium surface is also maintained and little or no significant capacity losses result from passivation film formation on fresh surfaces.

While it is known in the art to use graphite as a negative electrode it is also known that the reversible capacity and cycling efficiency of graphite is limited to about 340 mAHr/g. Much research and effort over the years has been directed, therefore, in finding ways of overcoming this limitation. In particular, methods for incorporating quantities of compounds/alloys of Sn, Al, Si, Cd, Pb, Bi and Sb in into the lattice of various types of carbonaceous materials to the graphite to increase the charging capacity of negative electrodes comprising these materials have been widely investigated. U.S. Pat. No. 6,477,956 to Ishii, et al., teaches to mix materials such as iron, nickel, titanium, silicon, and boron with graphite and then calcine the mixture at about 2800° C. in order to control the physical structure of the graphite particles. U.S. Pat. No. 6,395,427 to Sheem, et al., also teaches to mix soft carbon, silicon, and pitch and then to heat-treat the mixture at 2800° C. to provide a suitable electrode material. U.S. Pat. No. 5,624,606 to Wilson, et al., (claiming priority to Canadian Patent Application Serial No. 2,122,770, filed May 3, 1994) teaches to incorporate atoms of Sn, Al, Si, Cd, Pb, Bi and Sb, into a pre-graphitic carbonaceous host, particularly to insert compounds comprising nanodispersed silicon atoms wherein specific capacities of 550 mAHr/g were obtained. Similarly, Canadian Patent Application Serial No. 2,127,621, Alfred M. Wilson et al., ‘Carbonaceous Insertion Compounds and Use as Negative electrodes in Rechargeable Batteries’, filed Jul. 8, 1994 discloses that specific capacities of about 600 mAHr/g can be obtained by pyrolyzing siloxane precursors to make pre-graphitic carbonaceous compounds containing silicon. Finally, U.S. Pat. No. 6,316,144 to Xue, et al., discloses carbonaceous insertion compounds and methods prepared by simple pyrolysis of suitable epoxy, phenolic resin, or carbohydrate precursors at an appropriate temperature, wherein the prepared insertion compounds have large reversible capacity for lithium yet low irreversible capacity and voltage hysteresis.

Thus, while considerable effort has been expended heretofore, as evidenced by the above cited prior art. Most, if not all, of these proposed methods require some special processing to both create the carbon material used in the insertion compound as well as to incorporate the secondary metal alloy/compound into the carbon lattice. None of the foregoing prior art provides a simple cost-effective method for providing a negative electrode material with which to increase the energy density of lithium secondary cells. Moreover, Wilson, et al., (U.S. Pat. No. 5,624,606) teaches that simple mixing of carbon and silicon powders does not provide a negative electrode capable of sustained reversible capacity.

What is needed therefore is a simple and inexpensive method for providing a material for a negative electrode for a lithium-ion secondary cell capable of repeatable and reversible capacity greater than 340 mAHrs/g.

### SUMMARY OF THE INVENTION

The present embodiment comprises physical mixtures of graphitic carbon powders and powders of one or more of any of the metals or metalloids contained in New IUPAC Groups 12-15 of the Periodic Table of Elements that are capable of forming an alloy with lithium. The elements Zn, Cd, B, Al, In, Si, Sn, and Pb, Sb, and Bi are suitable, while silicon is most preferred.

The present embodiment further comprises processes for preparing said materials, and the use of said materials as electrodes in electrochemical devices comprising a lithium secondary cell.

Carbonaceous insertion materials of this embodiment can be used as portions of electrodes in electrochemical devices, a battery being an example of such a device. A preferred application would employ the insertion materials of the embodiment as the negative electrode material in a non-aqueous lithium ion battery.

It is, therefore, a principal object of this embodiment to produce a carbonaceous material containing a quantity of one or more of the new IUPAC Group Number metals or metalloids that results in improved discharge performance of lithium secondary electrochemical cells when the carbon mixture is employed as the active negative electrode material therein.

A principal aspect of the method of the present embodiment is directed to forming an essentially dry reagent mixture comprising graphite powder and powders of one or more of the materials selected from the list of elements, compounds and alloys consisting of Zn, Cd, B, Al, In, Si, Sn, and Pb, Sb, and Bi. Particulate rigid milling media are preferably added to the mixture prior to mechanical mixing. The elements, compounds and alloys of the Group 12-15 materials are first mixed with a rigid milling media and subjected to mechanical agitation for a period of up to 20 hours in order to reduce the average particle size of these materials to below about 1 μm. After comminuting the Group 12-15 material(s), an essentially dry graphite powder is added into the milling vessel and the two materials mixed by again agitating the milling media for several minutes in order promote an intimate association between the constituent materials. During mechanical agitation, therefore, a dry dispersion of graphite and the chosen Group 12-15 material(s) is formed.

The term “essentially dry” as used herein shall be understood to include the possibility of small amounts of residual water being present on the powdered materials, i.e., with small amounts of water physisorbed by the reagent mixture.

Further, the process of the present embodiment seeks to improve the precursor material used to prepare active negative electrodes for lithium-ion secondary cells by increasing the reversible capacity of the negative electrode material beyond about 340 mAHrs./g. A negative electrode material is thus prepared which includes a significant quantity of adducts capable of forming alloys with lithium and which exhibit much higher theoretical charge capacities for lithium than does carbon.

Thus, in one aspect of the embodiment of the present invention, an essentially dry mixture of graphite and a lithium intercalating and/or reacting material, such as silicon, is subjected to high-efficiency milling or grinding with a milling media at ambient temperature in dry air or an inert gas for a period of time ranging from about 0.5 hours to about 24 hours. The milled carbon/silicon product can include from about 10 wt % to about 95 wt % silicon.

It is a further object of the present embodiment to provide an electrochemical cell including a negative electrode containing the mixed carbon-metal powders prepared by the method of this embodiment. The cell positive electrode may be composed of any of the commonly known lithium-insertion materials. A suitable liquid electrolyte may be any non-aqueous solution containing an electrochemically stable lithium salt such as lithium hexafluorophosphate dissolved in an organic solvent such as propylene carbonate, ethylene carbonate, dimethyl carbonate, 1,2-dimethoxyethane, and mixtures thereof. The separator material may be any electrochemically stable, porous material such as 0.05 mm thick polypropylene film.

When included as the active negative electrode material in a secondary lithium-ion cell, the carbon-metal mixture, prepared by the method of the present embodiment, provides much higher reversible capacity and extended cycle life than do lithium-ion cells prepared using prior art materials. Accordingly, secondary lithium-ion cells containing the negative electrode materials of this embodiment are particularly useful for demanding high performance applications; for example, use in compact photographic cameras, digital cameras, digital video camcorders, cell phones, laptop computers, and PDAs.

Other features and advantages of the invention will be readily apparent from the description of the preferred embodiments and from the claims.

### BRIEF DESCRIPTION OF THE DRAWINGS

FIG. 1 is a typical example of one of the galvanostatic cell cycling experiments.

FIG. 2 is a plot of capacity vs. cycle number for the experiment of FIG. 1.

FIG. 3 is a plot of the discharge cycling results for several different materials tested.

FIG. 4 is shows the theoretical capacities based on the material's silicon and graphite composition. The (solid) data points are the maximum discharge capacities that we have actually observed with the materials investigated.

### DETAILED DESCRIPTION OF THE INVENTION

The process of the present embodiment of the invention involves forming a reagent mixture comprising graphite powder and a powder of a metal, an alloy, or a compound comprising one or more of the elements listed in new IUPAC Group Numbers 12-15 of the Periodic Table of Elements and subjecting the mixture to mechanical agitation. A predetermined amount of milling media is introduced into a suitable milling vessel together with one or more of the selected IUPAC Group Numbers 12-15 element or elements and mechanically agitated for a period of 1-24 hours. Reagent grade graphite powder is added to the previously milled Group 12-15 material(s), and this new mixture is mechanically agitated for an additional period of several minutes.

The material mixture, together with a milling media, is subjected to a milling process which imparts some quantity of mechanical energy to the powders for the purpose of mixing, comminuting, and/or mechanically alloying the milled materials. For the purposes of the present, milling is used to promote intimate mixing of the powders. The milling process is desirably carried out under ambient conditions, typically between about 15° C. and 35° C., preferably without external heating, in air or an inert gas. The resultant final product is separated from the milling media to prepare material for use as a negative electrode material for a lithium-ion secondary cell.

Mechanical milling is well known in the art and will not be discussed in detail here since many different types of equipment may be advantageously used to practice the present embodiment. A thorough review of typical milling processes and the general types of equipment used for milling is presented in U.S. Pat. No. 6,403,257 to Christian, et al., which is herein incorporated by reference. Of the major types of mixers described, the two most useful forms for practicing the present embodiment are the so-called rotary ball-tumbler and the vibratory or “shaker” ball mill.

In one embodiment of the present invention, an essentially dry powder consisting of reagent grade silicon is combined with milling media and is subjected to mechanical agitation at ambient temperature in an inert gas or air for a period of time ranging from about 0.5 hours to about 24 hours to form a comminuted powder. The preferred weight ratio of reagent mixture to milling media ranges from about 10:1 to 1:10. The preferred duration of mechanical agitation range from about 1 hour to about 4 hours. The preferred milling media are spherical ceramic media, such as tungsten carbide, or a hardened steel media, ranging in mean diameter from about 2 mm to about 25 mm. The milling media are constructed from tungsten carbide, while the milling vessel comprises a tungsten carbide-lined, high strength steel cylinder either closed at one end and sealed at the opposite end by a threaded cap, or opened at both ends and sealed at both ends by threaded caps also lined with tungsten carbide.

The mill engine used in the present embodiment is a SPEX CertPrep 8000M® high-energy mixer/mill.

After milling the silicon powder to reduce the average particle size to about 1 μm, a suitable quantity of graphite powder is introduced into the milling vessel and the vessel is again agitated for a period of between about 1 minute to about 1 hour, preferably about 15 minutes, in order to provide the mixed/milled carbon-silicon composite material of the present embodiment.

After mixing, the milling media can be separated from the mixed graphite/silicon powders using conventional separation techniques such as dry sieving through a mesh screen, vacuum filtration, or centrifugation.

It is theorized by the applicants that during the milling process of the present embodiment the mixing action of the milling media results in the application of a coating of soft carbon particles onto some or all of the surfaces of the harder silicon particles. In additional, it is known that after milling, the silicon powder comprises a high percentage of “fines;” particles much smaller than the average bulk particle size. It is further theorized that because of the size of the silicon particles and the quantity of graphite surrounding them, each particle is shielded from the electrolyte such that its deleterious effect on the silicon particles is substantially lessened. Thus, the graphite matrix surrounding the dispersed silicon particles serves a multi-purpose function. It acts as an electrical conductor; provides ionic connectivity; provides protection to the silicon particles by removing it from direct contact with the electrolyte; provides active storage through the intercalation of lithium; and lessens the capacity degradation that can be caused by lattice expansion of lithium-compound formation in the silicon.

Another embodiment of the present invention features inclusion of the graphite-composite material as the negative electrode material of a secondary lithium-ion cell. Secondary lithium cells can be fabricated in many different forms, including button or coin cells, prismatic or flat cells, as well as traditional cylindrical cells having a spirally-wound or “Swiss-roll” anode and cathode with a separator sheet positioned between the electrodes. Compositions for the secondary cell electrodes, separators, and electrolytes are generally well known in the art and are disclosed elsewhere (see for example U.S. Pat. Nos. 6,468,698; 6,489,055; and 4,980,250 as well as the references cited in each of these patents). In an embodiment of the present invention, the graphite-composite material, prepared by the method of this invention, is substituted advantageously for the prior art negative electrode materials.

The active negative electrode material of the present embodiment typically is mixed with a suitable polymeric binder, such as poly(tetrafluoroethylene), or polyvinylidene fluoride, and a coating vehicle, such as an organic solvent, in order to produce a paste or slurry that can be applied to an electrically-conductive substrate serving as a current collector, such as a metal grid, an expanded metal foam, or a metal foil, in order to form the negative electrode. Suitable metals for acting as current collectors are copper, nickel, or steel although others, such as the noble metals and certain other transition metals such as tantalum or molybdenum are also possible. Copper is preferred.

The active positive electrode materials include the lithiated oxides, sulfides, or phosphates of one or more of the transition metals. Materials that are typically chosen include the oxides of vanadium, chromium, manganese iron, cobalt, nickel, molybdenum, and the sulfides of titanium, and molybdenum. The cathode is prepared by any of the known art methods embodied in U.S. Pat. No. 5,211,933 to Barboux, et al., U.S. Pat. No. 5,434,024 to Ikeda, et al., and U.S. Pat. No. 5,219,680 to Fauteux, et al., herein incorporated by reference. Suitable metals for acting as current collectors are aluminum, nickel, or copper, although others, such as the noble metals, principally gold, platinum, rhodium, and palladium, and certain other transition metals such as tantalum or molybdenum are also possible. Aluminum is preferred.

A separator layer is located between the two electrodes. The separator layer typically consists of a porous polymer film or thin sheet that serves as a spacer and prevents electrical contact between the positive and negative electrodes while allowing electrolyte to move freely through the pores of the film. Suitable separator materials include those polymers that are relatively non-reactive, such as polypropylene, polyethylene, polyamide (i.e., nylon), polysulfone, or polyvinyl chloride (PVC). The separator has a preferred thickness between about 25 μm to about 200 μm and a more preferred thickness of about 50 microns.

The nonaqueous electrolyte can be any liquid nonaqueous electrolyte or combination of liquid nonaqueous electrolytes known in the art. The nonaqueous electrolyte can optionally include a polymeric electrolyte. Typically, liquid nonaqueous electrolytes suitable for use in a lithium secondary cell consist of a lithium electrolyte salt dissolved in a dry organic solvent or mixture of dry organic solvents. Suitable lithium electrolyte salts include: lithium perchlorate (LiClO₄), lithium trifluoro-methylsulfonate (LiCF₃SO₃), lithium hexafluorophosphate (LiPF₆), lithium hexafluoroarsenate (LiAsF₆), and lithium tetrafluoroborate (LiBF₄). Suitable organic electrolyte solvents include: diethyl carbonate (DEC), ethylene carbonate (EC), propylene carbonate (PC), butylene carbonate (BC), dimethylcarbonate (DMC), dimethoxyethane (DME), dioxolane, γ-butyrolactone, diglyme, and mixtures thereof. The preferred electrolyte composition consists of a 1 M solution of lithium hexafluoroarsenate (LiAsF₆), available under the trade name, Selectipur from Merck) dissolved in a mixture of “neat” carbonates such as ethylene carbonate (EC), and dimethyl carbonate (DMC). A solution of LiPF₆ also may be preferred as a replacement for the more toxic arsenic hexafluoride compound. Generally, Merck Selectipur® LP40 electrolyte was used. The composition of LP40 is 1 M LiPF₆ in 1:1 w/w diethyl carbonate (DEC): ethylene carbonate (EC).

The electrodes, separator, and liquid or polymeric nonaqueous electrolyte are contained within a case or can. The case can take the form of a coin cell, button cell, cylindrical cell, prismatic cell, laminar cell or other standard cell geometry. The case can be made of a metal such as nickel, nickel clad or plated steel, stainless steel, aluminum or a polymeric material such as PVC, polypropylene, polysulfone, acrylic acid-butadiene-styrene terpolymer (ABS), or polyamide. After the nonaqueous electrolyte solution is added to the cell, the case is tightly sealed to confine the electrolyte and inhibit infiltration by moisture and air into the cell.

The following examples illustrate embodiments of the present invention.

### EXAMPLE 1

A SPEX CertPrep 8000M® high-energy shaker mixer/mill was used for milling and mixing the materials of the present embodiment. However, using a high-energy mill such as the SPEX mill is not critical. Since the intent of this embodiment was to achieve size reduction and intimate contact rather than such other effects such as mechanical alloying, lower energy mills such as tumblers and low speed shearing mills are possible and should be equally effective as the present shaker mixer/mill.

The milling vessel was a standard model tungsten carbide (WC) lined cylinder (also available from SPEX CertPrep®) and has an internal volume of roughly 100 mL, and can be sealed by compressing flat rubber or cork gaskets at either end of the cylinder between the cylinder wall and two threaded end caps. Several nominally 10 mm WC balls are used as the grinding media. Particle size reduction may be somewhat better in the shaker mixer/mill than in lower energy mills, but milling for longer periods of time, or using higher milling powers, can create carbides in the mixed powders.

A total silicon weight of about 6 grams was used. Generally, however, a measured quantity (5 grams-20 grams) of 60 mesh silicon powder purchased from the Aldrich Chemical Company or some similar supplier, was milled under an argon atmosphere for 4 hours with 4-12 tungsten carbide balls in the SPEX milling apparatus described above.

Normally, silicon is milled long enough to form a “nanocrystalline” microstructure (particle sizes are sub-micron, but crystallite “fines” are ˜30 nm-50 nm). Graphite is milled separately so that the carbon and silicon do not react during milling to form inactive silicon-carbides. When milled the graphite will either retain its crystallinity or become amorphous depending on the intensity and duration of milling. Carbon, either in the form of graphite or in other forms such as amorphous carbon, or combinations of different forms of carbon, should work as the carbon component of the carbon-silicon composite. However, graphite is the preferred form of carbon.

After milling the silicon for a predetermined time the graphite powder is added to the milled silicon and the powder combination mixed, rather than milled, for a period between about 1 minute and 5 hours; usually about 15 minutes. Therefore, silicon is milled for periods between about 0.5 hours to about 24 hours and graphite is added for only a final 15 minutes of milling. The equipment typically used to mix these kinds of powders consist of Turbula® mills, single and dual-cone blenders, stirred single dual-cone blenders, “V” blenders, horizontal troughs with rotary agitation ribbons, vibrating ball mill, and multi-axial shaker/mixer, and combinations of this equipment.

In the present embodiment, the preferred weight of the carbon added to the milled silicon ranges from about 10% by weight to about 95% by weight of the milled silicon. Graphite/silicon composites with the following compositions (in weight percent) were actually prepared in the foregoing manner described above: 90% C/10% Si, 80% C/20% Si, 70% C/30% Si, and 60% C/40% Si.

Composite graphite/silicon negative electrodes were prepared in the following manner: a slurry is made of a mixture of the powder and a polymer binder comprising polyvinylidene fluoride (PVDF) dissolved in a solvent such as n-methyl-2-pyrrolidinone (NMP). The slurry is pasted onto a copper foil and dried under vacuum at 120° C. for about 2 hours. After the foil is dry, electrode discs are punched out of the foil using a ½″ diameter punch and die.

When prepared this way, each of the negative electrodes typically have about 10 mg of the active C/Si composite material. The exact ratios for the powder/binder mixtures need to be optimized for each system to obtain a suitable viscosity for the slurry. A powder/binder ratio of 90 wt % powder and 10 wt % PVDF, and binder solution comprising 5 wt % PVDF/95 wt % NMP was settled on for the present embodiment.

“Cells” are assembled by placing the punched electrode disc together with a lithium foil as the counter electrode and an intervening disc of separator material. CELGARD® polypropylene is used as the separator which is saturated with one of the Merck SELECTIPUR® series of electrolytes (typically 1 M LiPF₆ dissolved in a mixture of ethylene carbonate and dimethyl carbonate). This assembly is then fitted into a custom built Swagelok-type cell fixture. These cells are sealed under an inert atmosphere in an argon-filled glove box.

All of the cell cycling is performed galvanostatically, i.e., at constant current. A full cycle is defined by the following 4 steps:

1. Applying a cathodic current (Li insertion into Si/C) until a cathodic voltage limit is reached; 50 mV vs. Li/Li⁺ in the present embodiment.

2. Resting the cell at open-circuit for 30 minutes;

3. Applying an anodic current (Li removal from Si/C) until an anodic voltage limit is reached; 1000 mV vs. Li/Li⁺ in the present embodiment. Current density is always the same as in step 1.; and

4. Resting the cell at open-circuit for 30 minutes.

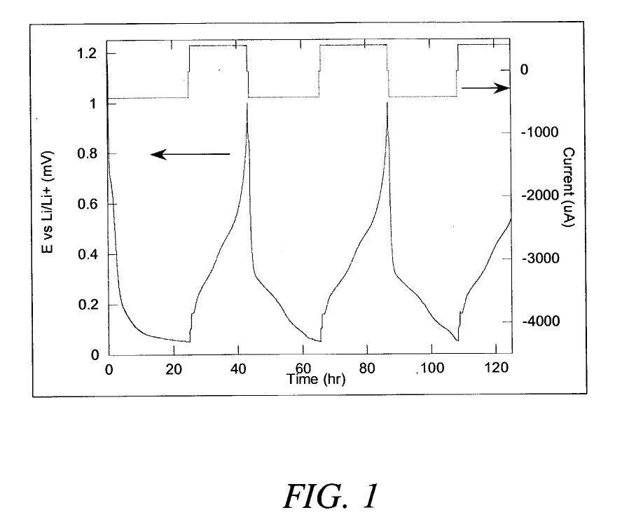

The cells prepared in the manner described above have been tested through 20 cycles or more. FIG. 1 is a typical plot of one these experiments. The current is controlled and the voltage is measured.

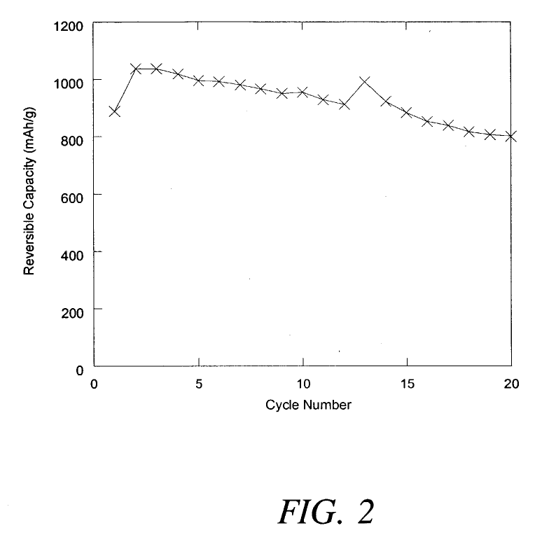

From these plots, we generate the capacity vs. cycle number experiments shown in FIG. 2. The capacity is given by Cₛ=It/m, where Cₛ is the specific capacity (mAHr/g), I is the current (mA), t is time to reach the voltage limit in step 1 or step 3 (hr), and m is the mass of the active material in the electrode. In the present case, the mass of both the carbon and silicon are counted as active material. Each material comprises two curves on these plots, consisting of an insertion capacity (from step 1) and a discharge capacity (from step 3). We want the discharge capacity to be as high as possible (large energy density) and as close to the insertion capacity as possible so that the efficiency for Li insertion/removal is high. Graphite has a benchmark of about 340 mAHr/g for the discharge capacity and is currently the most common material used in lithium-ion secondary cells. Moreover, graphite can operate over hundreds of cycles without much loss in capacity and this longevity is the most difficult issue for metallic electrodes. The composite materials of the present embodiment have significantly higher capacities than graphite alone and have cycle lives that are much improved over prior art silicon-based electrode materials.

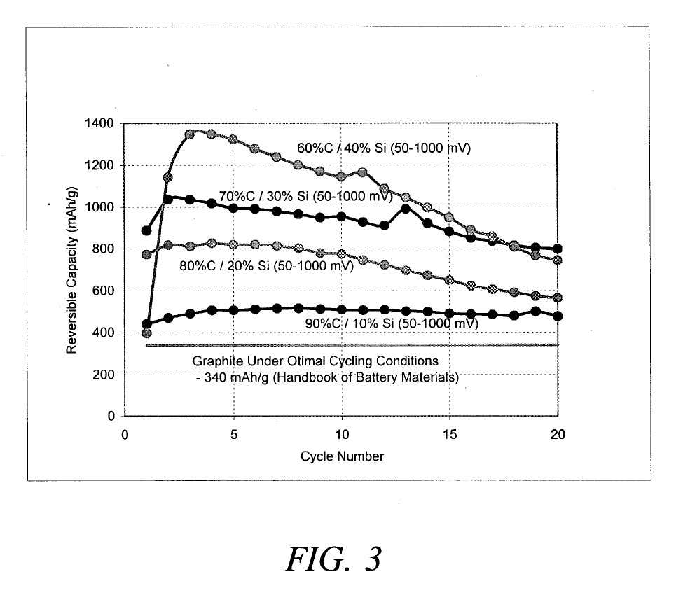

In FIG. 3, a plot of the cycling results of the discharge capacities are shown for composite negative electrodes having several different graphite/silicon compositions.

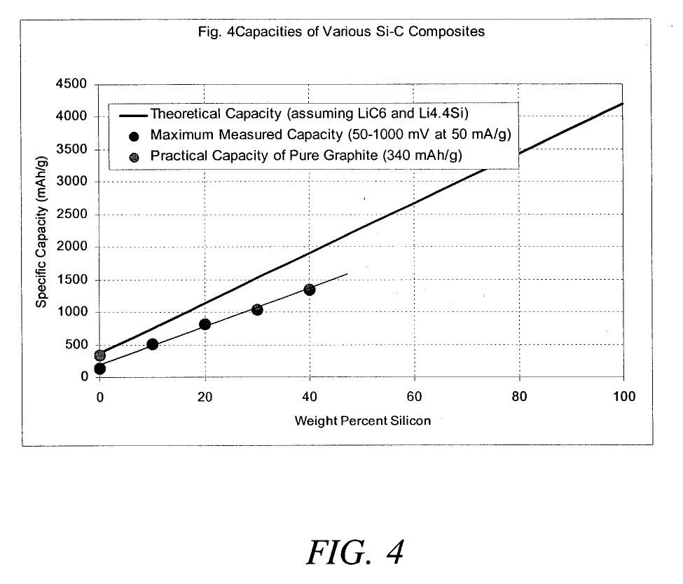

FIG. 4 shows the theoretical capacities based on the material's silicon and graphite composition. The data points are the maximum discharge capacities that we have actually observed with our materials.

What is claimed is:

1. A process for preparing a negative electrode material for a secondary electrochemical cell, comprising the steps of:
(a) comminuting a material or a group of materials comprising one or more of the elements selected from the list consisting of Zn, Cd, B, Al, In, Si, Sn, Pb, Sb, and Bi to provide a first powder, wherein said material or group of materials is capable of forming an alloy with lithium;
(b) combining graphite powder with said first powder to provide a powder mixture; and;
(c) agitating said powder mixture with a mixing aid to form a composite powder.

2. The process of claim 1, wherein the material or group of materials are pure elements, compounds, alloys, or combinations thereof.

3. The process of claim 2, wherein the step of comminuting comprises milling with a milling media, wherein said milling media comprise rigid chemically inert bodies which do not react with said material or group of materials or said graphite powder.

4. The process of claim 3, wherein said milling media and said powder mixture has a weight ratio of between about 10:1 to about 1:10.

5. The process of claim 3, wherein the step of comminuting comprises a container for containing the material or materials and the milling media, and wherein the container engages a milling apparatus selected from the group consisting of a high energy ball mill, a planetary mill, a stirred ball mill, a vibrating ball mill, a multi-axial shaker/mixer, and any combination thereof.

6. The process of claim 3, wherein the step of comminuting comprises milling for a period of about 0.5 hours to about 24 hours at a temperature of between about 15° C. and about 35° C.

7. The process of claim 5, wherein the step of comminuting further comprises comminuting under an atmosphere comprising one or more of the gases selected from the group consisting essentially of air, an inert gas, and combinations thereof.

8. The process of claim 7, wherein the step of combining further comprises adding said graphite powder into said container.

9. The process of claim 8, wherein the step of combining further comprises adding graphite powder to said first powder in an amount equal to about 10% by weight to about 95% by weight of said weight of said first powder.

10. The process of claim 8, wherein the step of agitating comprises mixing for a period of about 1 minute to about 5 hours at a temperature of between about 15° C. and about 35° C.

11. The process of claim 8, wherein the step of combining comprises a container for containing said powder mixture, and wherein the container engages an apparatus selected from the group consisting of Turbula® mills, single and dual-cone blenders, stirred single dual-cone blenders, “V” blenders, horizontal troughs with rotary agitation ribbons, vibrating ball mills, and multi-axial shaker/mixers, and any combination thereof.

12. The process of claim 1, wherein said mixing aid comprises said milling media, a stirrer paddle or paddles, a stirrer blade or blades, a helical agitator ribbon, or combinations thereof.

13. The process of claim 7, wherein the step of comminuting further comprises milling under an atmosphere comprising one or more of the gases selected from the group consisting essentially of air, an inert gas, and combinations thereof.

14. A process for preparing a negative electrode material for a secondary electrochemical cell, comprising the steps of:
(a) combining a graphite powder with silicon powder to provide a powder mixture; and;
(b) agitating said powder mixture with a mixing aid to form a graphite/silicon composite powder.

15. The process of claim 14, wherein the step of combining comprises mixing with or without a mixing aid.

16. The process of claim 15, wherein the step of combining comprises a container for containing said powder mixture, and wherein the container engages an apparatus selected from the group consisting of Turbula® mills, single and dual-cone blenders, stirred single dual-cone blenders, “V” blenders, horizontal troughs with rotary agitation ribbons, vibrating ball mills, and multi-axial shaker/mixers, and any combination thereof.

17. The process of claim 16, wherein the step of combining further comprises mixing under an atmosphere comprising one or more of the gases selected from the group consisting essentially of air, an inert gas, and combinations thereof.

18. The process of claim 14, wherein the step of combining further comprises adding graphite powder to said silicon powder in an amount equal to about 10% by weight to about 95% by weight of said weight of said first powder.

19. The process of claim 17, wherein the step of agitating comprises mixing for a period of about 1 minute to about 5 hours at a temperature of between about 15° C. and about 35° C.

20. The process of claim 14, wherein said mixing aid comprises said milling media.

21. The process of claim 17, wherein the step of agitating further comprises milling under an atmosphere comprising one or more of the gases selected from the group consisting essentially of air, an inert gas, and combinations thereof.

22. A secondary lithium-ion electrochemical cell comprising a case; positive and negative terminals; a cathode comprising an oxide, sulfide, or phosphate of one or more of the transition metals listed in new IUPAC Group Numbers 4-12 of the Periodic Table of Elements, a nonaqueous electrolyte comprising a lithium salt and an organic solvent; and a negative electrode, comprising:
(a) one or more comminuted materials selected from the elements listed in new IUPAC Group Numbers 12-15 of the Periodic Table of Elements, wherein said one or more comminuted materials are capable of forming an alloy with lithium; and
(b) graphite powder, wherein said graphite powder and said one or more comminuted materials are combined with a milling media and milled together to form a graphite/silicon composite powder.

23. A secondary lithium electrochemical cell comprising a case; positive and negative terminals; a cathode comprising an oxide or sulfide of one or more of the transition metals listed in new IUPAC Group Numbers 4-12 of the Periodic Table of Elements, a nonaqueous electrolyte comprising a lithium salt and a dry organic solvent; and a negative electrode comprising:
(a) a silicon powder; and
(b) graphite powder, wherein said graphite powder and said silicon powder are combined with a milling media and milled together to form a graphite/silicon composite powder.
